(19) United States
(12) Patent Application Publication
(10) Pub. No.: US 2013/0258505 A1
(43) Pub. Date: Oct. 3, 2013

(54) OPTICAL APPARATUS AND METHOD OF MANUFACTURING THE SAME

(71) Applicants: Nobuyuki YASUI, Tokyo (JP); Takehiko Nakahara, Tokyo (JP); Masaya Shimono, Tokyo (JP); Keiichi Fukuda, Tokyo (JP); Keita Mochizuki, Tokyo (JP); Hiroshi Aruga, Tokyo (JP); Kenichi Uto, Tokyo (JP); Tadashi Murao, Tokyo (JP); Hidekazu Kodera, Tokyo (JP)

(72) Inventors: Nobuyuki YASUI, Tokyo (JP); Takehiko Nakahara, Tokyo (JP); Masaya Shimono, Tokyo (JP); Keiichi Fukuda, Tokyo (JP); Keita Mochizuki, Tokyo (JP); Hiroshi Aruga, Tokyo (JP); Kenichi Uto, Tokyo (JP); Tadashi Murao, Tokyo (JP); Hidekazu Kodera, Tokyo (JP)

(21) Appl. No.: 13/778,472

(22) Filed: Feb. 27, 2013

(30) Foreign Application Priority Data
Apr. 3, 2012 (JP) 2012-084778
Oct. 10, 2012 (JP) 2012-224968

(51) Int. Cl. G02B 7/00

(52) U.S. Cl. CPC G02B 7/003
USPC 359/819; 264/1.37

(57) ABSTRACT

A method of manufacturing an optical apparatus having an optical element, a holding member, and a base member includes preparing the holding member and fixing the optical element to the first member. The method further includes fixing a second member of the holding member to the base member and plastically deforming a first member of the holding member and the second member to adjust the position of the optical element.

### BACKGROUND OF THE INVENTION

1. Field of the Invention

The present disclosure relates to an optical apparatus and a method of manufacturing the same, and more particularly relates to optical alignment of an optical apparatus.

2. Description of the Related Art

In recent years, communication traffic loads have been increasing in optical networks, and there have been demands for optical transmitters that have large communication capacity while being smaller in size and lower in power consumption. For example, US 2011/0,013,869 A discloses an optical transmitter that includes four laser light sources of different wavelengths, an optical multiplexer, and four lenses optically coupling the four laser light sources and the single optical multiplexer. This optical transmitter has large communication capacity while being small in size. In this optical transmitter, the four laser light sources and the single optical multiplexer need to be optically aligned so as to achieve high optical coupling efficiencies with less differences. Therefore, the laser light sources, the lenses, and the optical multiplexer need to be respectively assembled with a high degree of accuracy.

In the optical transmitter according to US 2011/0013869 A, four laser light sources are fixed onto a silicon substrate by soldering. Each of the laser light sources emits light of a different wavelength. An optical multiplexer (planar lightwave circuit: PLC) is mounted on the silicon substrate. Beams of light emitted from the respective laser light sources are condensed into incident optical waveguides of the optical multiplexer (PLC) using ball lenses. Each of the ball lenses is retained by a lens holder, and this lens holder has a spring and a handle that are integrally formed by etching the silicon substrate. The spring has a zigzag structure, being stretchable to some extent and bendable upward, downward, rightward and leftward, so that the handle can be displaced three dimensionally. The other end of the handle is fixed to the silicon substrate in an immovable manner. Thus, on the basis of the principle of leverage, the motion of the ball lens corresponds to the motion of the handle being decreased by a ratio of the distance between the fulcrum and the point of effort to the distance between the fulcrum and the point of load.

During positional adjustment of a lens, in comparison to the optical axis direction (for example, Z direction), tolerance (allowable error) of the optical alignment in two directions (X and Y directions) perpendicular to the optical axis direction is generally stricter. In the technique according to US 2011/0013869 A, the upward, downward, rightward and leftward motion of the handle can be converted to small motion of the ball lens in the two directions (X and Y directions) perpendicular to the optical axis direction, therefore, the optical alignment is facilitated. Furthermore, there are provided a metal layer near the handle, and a thick solder layer on the metal layer that generates heat when electric current flows on the silicon substrate located on both lateral sides of the metal layer. Light is emitted from the laser light source, and the handle is adjusted so as to maximize the optical coupling efficiency of the optical multiplexer (PLC). Subsequently, when electric current is applied to the metal layer, the solder layer is melted to flow and fill the periphery of the metal layer so as to fix the handle.

The optical transmitter according to US 2011/0013869 A is designed to convert positional aberration of the handle upon solidification of the solder into small positional aberration of the ball lens on the basis of the principle of leverage, thereby preventing deterioration in optical coupling efficiency. However, in an actual case, the positional aberration of the ball lens cannot be perfectly eliminated, resulting in deterioration in optical coupling efficiency, since the tolerance of the optical alignment is stricter in the two directions (X and Y directions) perpendicular to the optical axis direction. Particularly, in case of achieving optical coupling between each of a plurality of laser light sources and an optical multiplexer (PLC), since there are differences in amount of positional aberration for the respective ball lenses, it is therefore difficult to decrease the differences in optical coupling efficiency.

JP 2-308209 A (1990) proposes a technique of increasing the optical coupling efficiency in a semiconductor light emitting apparatus including plastically deformable lens holders, wherein each of the lens holders is plastically deformed by external force after the lens holders have been fixed. If this technique is applied to coupling beams of light emitted from a plurality of light emitting devices to an optical multiplexer with use of a plurality of lenses, work spaces around the lenses are limited and thus external force needs to be applied using tweezers or the like. However, in optical transmitters required to be smaller with more integration, such tweezers used to apply external force may possibly interfere with neighboring lens holders, so that the adjustment work is hard to achieve.

JP 2005-43479 A (FIGS. 10 and 11) and JP 2005-214776 A (FIGS. 12 and 13) each propose a technique of adjusting an inclination angle of an optical axis by utilizing contraction due to melting and solidification at an irradiation point upon irradiation with laser light. In this technique, two cylindrical cases each retaining a lens and an optical fiber are fixed by laser welding to a main housing accommodating a single light emitting device, and then lateral surfaces of the cylindrical cases are irradiated with laser light so as to adjust inclination angles of optical axes of the respective cylindrical cases. However, when a plurality of optical modules are densely disposed on the same substrate, irradiation with laser light is difficult in any direction.

### SUMMARY OF THE INVENTION

It is an object of the present disclosure to provide an optical apparatus and a method of manufacturing the same, which can achieve accurate and quick optical alignment in two directions perpendicular to an optical axis direction.

In order to achieve the above object, the present disclosure provides a method of manufacturing an optical apparatus, the optical apparatus including:

an optical element having an optical axis in a predetermined direction;

a holding member for holding the optical element; and

a base member onto which the holding member is fixed;

the method including steps of:

preparing the holding member having a first member that extends along a first direction perpendicular to an optical axis direction and a second member that extends along a second direction perpendicular to both the optical axis direction and the first direction;

fixing the optical element to the first member;

fixing the second member to the base member;

plastically deforming the first member by irradiation with laser light to adjust the position of the optical element in the first direction; and

plastically deforming the second member by irradiation with laser light to adjust the position of the optical element in the second direction.

It is preferable that the method further includes, before the steps of fixing the optical element and fixing the second member, steps of:

preparing a second optical element to be optically coupled with the optical element; and

aligning the optical axis of the optical element with that of the second optical element so as to maximize optical coupling between the optical element and the second optical element; wherein, in the step of fixing the optical element to the first member, the optical element is fixed at a position displaced by a predetermined offset distance in a direction opposite to a plastically deforming direction with respect to a maximum optical coupling position thereof, and

in the step of fixing the second member to the base member, the second member is fixed at a position displaced by a predetermined offset distance in a direction opposite to a plastically deforming direction with respect to a maximum optical coupling position thereof.

It is preferable that the holding member has one first member and two second members that are connected to both ends of the first member.

It is preferable that the holding member further has a third member that extends along the second direction, and

in the step of fixing the optical element to the first member, the third member is interposed between the optical element and the first member.

It is preferable that the optical apparatus comprises:

a lens serving as the optical element,

a laser light source that is optically coupled with the lens,

an optical multiplexer that is optically coupled with the lens, and

a substrate on which the laser light source, the optical multiplexer, and the base member are mounted.

Further, an optical apparatus according to the present disclosure includes:

an optical element having an optical axis in a predetermined direction;

a holding member for holding the optical element; and

a base member onto which the holding member is fixed;

wherein the holding member has a first member that extends along a first direction perpendicular to an optical axis direction and a second member that extends along a second direction perpendicular to both the optical axis direction and the first direction, and

each of the first member and the second member is made of a material that is plastically deformable by irradiation with laser light.

Furthermore, another optical apparatus according to the present disclosure includes:

a lens having an optical axis in a predetermined direction;

a lens cylinder accommodating the lens;

a holding member for holding the lens cylinder; and

a base member onto which the holding member is fixed;

wherein the holding member has a first member that extends along a first direction perpendicular to an optical axis direction and a second member that extends along a second direction perpendicular to both the optical axis direction and the first direction,

each of the first member and the second member is made of a material that is plastically deformable by irradiation with laser light, and

the lens cylinder has a lateral surface connected with the first member.

It is preferable that the second member is provided with an opening into which the lens cylinder is partially inserted.

It is preferable that the holding member has one first member, and two second members that are connected to both ends of the first member.

It is preferable that the holding member has one first member, and one second member that is connected to a one end of the first member.

It is preferable that the holding member further has a third member that extends along the optical axis direction, and the lens cylinder is connected with the third member.

It is preferable that each of the first member and the second member is configured of a flat plate.

It is preferable that the lateral surface of the lens cylinder is provided with a flat portion, and the lens cylinder is connected with the retentive member via the flat portion.

It is preferable that the lens cylinder is connected with the holding member using an adhesive or by welding.

According to the present disclosure, the position of the optical element can be adjusted in the first direction by plastically deforming the first member that extends along the first direction by irradiation with laser light. Also, the position of the optical element can be adjusted in the second direction by plastically deforming the second member that extends along the second direction by irradiation with laser light. As a result, it is possible to achieve accurate and quick optical alignment in the two directions perpendicular to the optical axis direction.

### BRIEF DESCRIPTION OF THE DRAWINGS

FIG. 1 is a configuration view showing an example of an optical transmitter to which the present disclosure can be applied;

FIG. 2 is a perspective view showing an example of configuration of a lens holder;

FIG. 3 is an explanatory view showing plastic deformation caused by irradiating a horizontal member with laser light;

FIG. 4 is an explanatory view showing plastic deformation caused by irradiating each of vertical members with laser light;

FIG. 5 is an explanatory view showing plastic deformation caused by irradiating a center portion of the horizontal member with laser light;

FIG. 6 is a graph indicating tolerance curves before and after irradiation to an irradiation area of the horizontal member shown in FIG. 2 with YAG laser light;

FIG. 7 is a graph indicating relationship between an energy of YAG laser light and an amount of displacement of a lens;

FIG. 8 is a perspective view showing another example of configuration of a lens holder;

FIG. 9 is a flowchart showing an example of a method of manufacturing an optical apparatus according to the present disclosure;

FIGS. 10A to 10C are configuration views according to Embodiment 2 of the present disclosure: FIG. 10A being a front view; FIG. 10B being a plan view; and FIG. 10C being a side view;

FIGS. 11A to 11C are configuration views according to Embodiment 3 of the present disclosure: FIG. 11A being a front view; FIG. 11B being a plan view; and FIG. 11C being a side view;

FIGS. 12A to 12C are configuration views according to Embodiment 4 of the present disclosure: FIG. 12A being a front view; FIG. 12B being a plan view; and FIG. 12C being a side view;

FIGS. 13A to 13C are configuration views according to Embodiment 5 of the present disclosure: FIG. 13A being a front view; FIG. 13B being a plan view; and FIG. 13C being a side view;

FIGS. 14A to 14C are configuration views according to Embodiment 6 of the present disclosure: FIG. 14A being a front view; FIG. 14B being a plan view; and FIG. 14C being a side view;

FIGS. 15A to 15C are configuration views according to Embodiment 7 of the present disclosure: FIG. 15A being a front view; FIG. 15B being a plan view; and FIG. 15C being a side view;

FIGS. 16A to 16C are configuration views according to Embodiment 8 of the present disclosure: FIG. 16A being a front view; FIG. 16B being a plan view; and FIG. 16C being a side view;

FIGS. 17A to 17C are configuration views according to Embodiment 9 of the present disclosure: FIG. 17A being a front view; FIG. 17B being a plan view; and FIG. 17C being a side view;

FIGS. 18A to 18C are configuration views according to Embodiment 10 of the present disclosure: FIG. 18A being a front view; FIG. 18B being a plan view; and FIG. 18C being a side view.

### DETAILED DESCRIPTION OF THE PREFERRED EMBODIMENTS

This application is based on the applications No. 2012-84778 filed on Apr. 3, 2012 and No. 2012-224968 filed on Oct. 10, 2012 in Japan, the disclosures of which are incorporated herein by reference.

Hereinafter, preferred embodiments will be described with reference to drawings.

### Embodiment 1

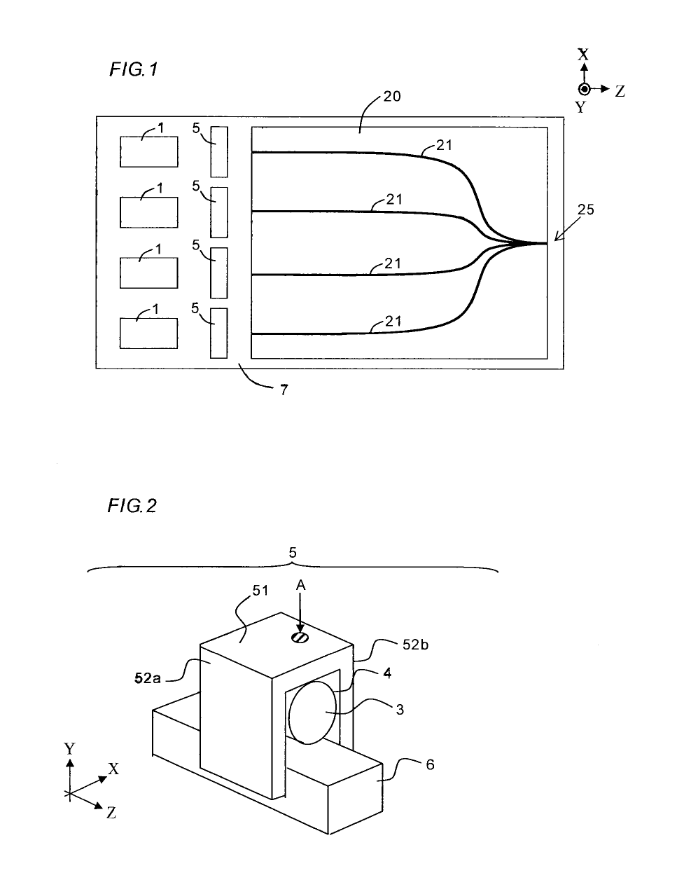

FIG. 1 is a configuration view showing an example of an optical transmitter to which the present disclosure can be applied. The optical transmitter has a function of simultaneously transmitting optical signals through a plurality of communication channels in a wavelength division multiplex mode or the like. Exemplified herein are four communication channels, while two, three, five or more communication channels can be configured in a similar manner.

The optical transmitter includes four laser light sources 1, four lens holders 5, an optical multiplexer 20, and a substrate 7.

The laser light sources 1, which can be each configured of a semiconductor laser, a solid state laser or the like, generate light having center wavelengths different from each other in the wavelength division multiplex mode. The laser light sources 1 are bonded onto a submount (not shown) using a solder or an adhesive. The submount is fixed onto the substrate 7 using a solder or an adhesive. Such a submount may be replaced with an LD carrier, in which the laser light sources are fixed to the substrate 7 with the LD carrier being interposed therebetween. Each of the laser light sources 1 is connected with a drive circuit, a modulation circuit and the like to generate a pulse of light that is modulated at high speed in accordance with an external digital signal.

Each of the lens holders 5 holds a lens for condensing laser light outputted from corresponding one of the laser light sources 1. The laser light thus condensed is guided into each of light incident ports that are provided for the communication channels in the optical multiplexer 20.

The optical multiplexer 20, which may be configured as a planar lightwave circuit (PLC), includes four light incident ports, four waveguides 21, and a single light exit port 25 to have a function of transmitting and multiplexing the laser light outputted respectively from the laser light sources 1. Generally, the light exit port 25 is optically coupled with an optical fiber and is further connected to an external communication network. The optical multiplexer 20 is fixed onto the substrate 7 using an adhesive.

The substrate 7 is made of a metal material, such as CuW or Kovar, onto which various components, such as the laser light sources 1, the lens holders 5, and the optical multiplexer 20, are mounted and fixed.

In this embodiment, for the purpose of easier comprehension, the optical axis direction of the laser light sources 1 is defined as Z direction, the direction perpendicular to the optical axis direction and parallel to the principal plane of the substrate 7 is defined as X direction, and the direction perpendicular to the optical axis direction and perpendicular to the principal plane of the substrate 7 is defined as Y direction.

FIG. 2 is a perspective view showing an example of configuration of the lens holder 5. The lens holder 5 includes a horizontal member 51 that extends along X direction, two vertical members 52a and 52b that extend along Y direction from both ends of the horizontal member 51, and has a shape of so-called gantry. Alternatively, the lens holder 5 may be configured of a single horizontal member and a single vertical member so as to be L-shaped. A lens 3 is accommodated in a lens cylinder 4, which is held by the lens holder 5 to have the optical axis thereof in Z direction. The vertical members 52a and 52b are fixed to a holder carrier 6 that serves as a base member.

Each of the horizontal member 51 and the vertical members 52a and 52b is made of a material, such as stainless steel or silicon steel, that is plastically deformable by irradiation with laser light for processing, such as a YAG laser, and is preferably formed of a stainless steel plate having a thickness of 0.3 to 0.4 mm. Each of the lens cylinder 4 and the holder carrier 6 is preferably made of a material similar to that of the horizontal member 51 and the vertical members 52a and 52b. The lens cylinder 4 is fixed to a center portion of the horizontal member 51 by YAG laser welding or the like.

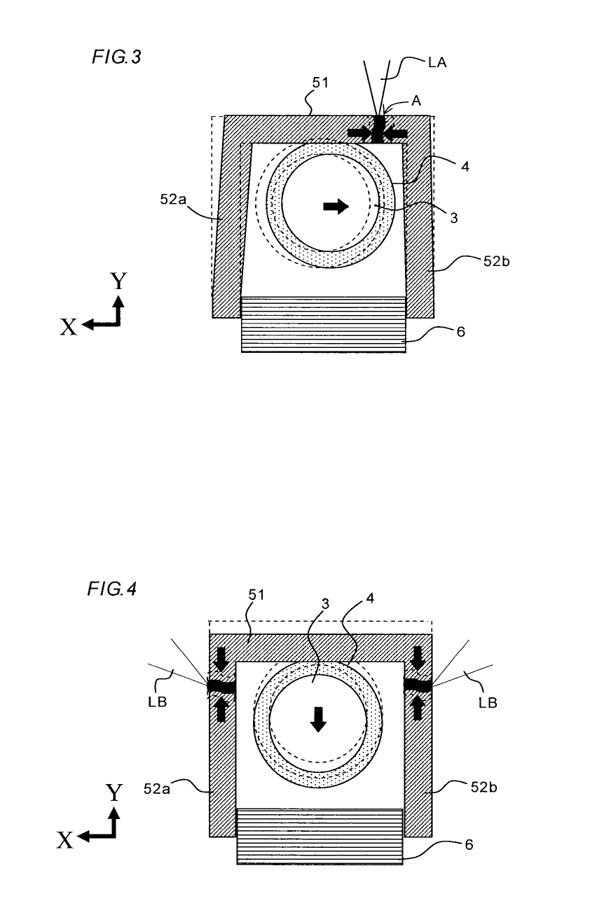

FIG. 3 is an explanatory view showing plastic deformation caused by irradiating the horizontal member 51 with laser light LA. In a case where the horizontal member 51 is formed of a stainless steel plate having a thickness of 0.3 mm, when a position deviating from the center portion of the horizontal member 51 and close to the vertical members 52a and 52b, for example, an irradiation area A of the horizontal member 51 as shown in FIG. 2, is spot-irradiated with the laser light LA of a YAG laser or the like, contraction occurs due to melting and solidification of the stainless steel. Because of this contracting deformation, an upper portion of the vertical member 52b close to the irradiation area A is slightly pulled toward the center portion, while an upper portion of the vertical member 52a far from the irradiation area A is remarkably pulled toward the center portion. As a result, in accordance with the difference in amount of warp between the respective members, the lens cylinder 4, which is fixed to the center portion of the horizontal member 51, is displaced in −X direction and then brought in a stationary condition. To the contrary, when a position close to the vertical member 52a is spot-irradiated, the lens cylinder 4 can be displaced in X direction because of the contracting deformation of the material.

FIG. 4 is an explanatory view showing plastic deformation caused by irradiating the vertical members 52a and 52b with laser light LB. In a case where the vertical members 52a and 52b are each formed of a stainless steel plate having a thickness of 0.3 mm, when each of the vertical members 52a and 52b is simultaneously spot-irradiated with the laser light LB of a YAG laser or the like, contraction occurs due to melting and solidification of the stainless steel. Because of this contracting deformation, the upper portions of the vertical members 52a and 52b are displaced downward. As a result, the both ends of the horizontal member 51 are displaced in Y direction, and the lens cylinder 4, which is fixed to the center portion of the horizontal member 51, is also displaced in −Y direction and then brought in a stationary condition.

Such displacement in −Y direction may be caused by spot-irradiation to the following position with laser light of a YAG laser or the like. FIG. 5 is an explanatory view showing plastic deformation caused by irradiating an area A2 of the horizontal member 51 above the lens 3 with laser light LC. This area A2 is preferably located near the center portion of the horizontal member 51. When the irradiation area A2 is spot-irradiated with the laser light LC, contraction occurs due to melting and solidification of the stainless steel. Because of this contracting deformation, the center portion of the horizontal member 51 is displaced downward, while the upper portions of the vertical members 52a and 52b are respectively displaced toward the center portion. As a result, the lens cylinder 4 is also displaced in −Y direction and then brought in a stationary condition.

By utilizing plastic deformation caused by irradiation with laser light in this manner, it is possible to achieve fine adjustment of the position of the lens 3 in both of X direction and Y direction. The amount of positional adjustment of the lens 3 can be controlled by various irradiation parameters, such as period of irradiation with laser light, irradiation power, the number of times of irradiation, and position of irradiation. Because laser light can be irradiated from above the substrate 7, positional aberration of the lens 3 can be easily corrected even after the lens holder 5 is fixed onto the substrate 7.

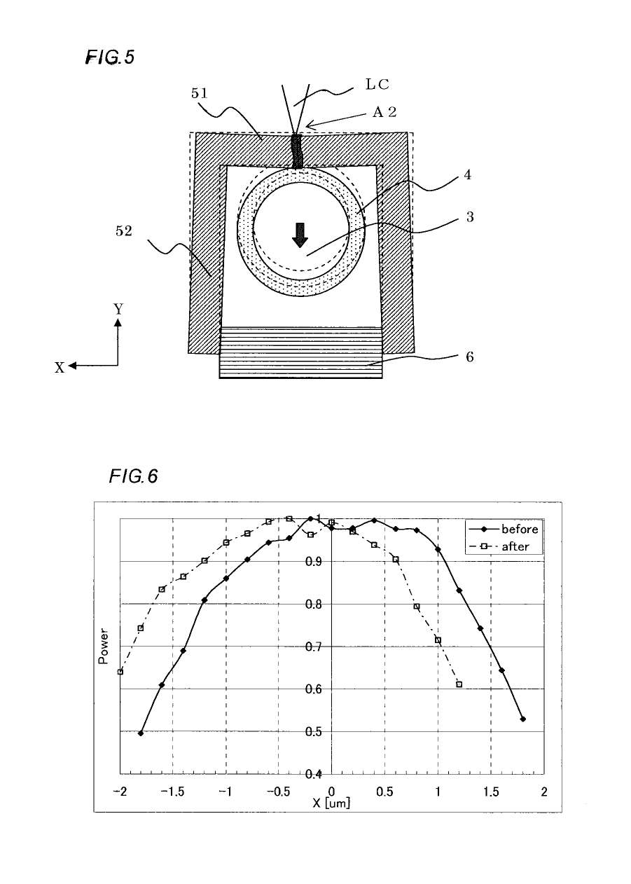

FIG. 6 is a graph indicating tolerance curves before and after irradiation to the irradiation area A of the horizontal member 51 shown in FIG. 2 with YAG laser light. The ordinate axis indicates an optical power obtained from the light exit port 25 of the optical multiplexer 20, while the abscissa axis indicates an amount of displacement (μm) of the lens 3 in X direction. The solid line indicates the tolerance curve before irradiation with laser light, while the dashed line indicates the tolerance curve after irradiation with laser light. As apparent from this graph, the tolerance curve itself is entirely shifted in −X direction between before and after irradiation with laser light. From this amount of shift, it is possible to obtain the amount of displacement caused by YAG laser irradiation.

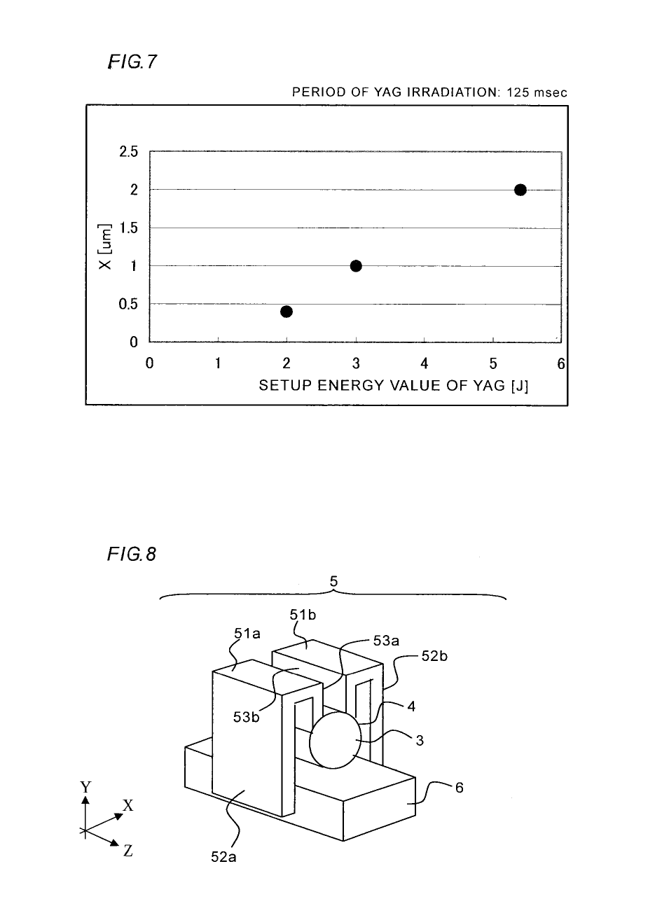

FIG. 7 is a graph indicating the relationship between an energy of the YAG laser light and an amount of displacement of the lens. The ordinate axis indicates an amount of displacement (μm) of the lens in X direction, while the abscissa axis indicates a setup energy value (joule: J) of the YAG laser light. The period of irradiation with laser light is 125 msec. If the setup energy value of the YAG laser is 2 J, the amount of displacement is approximately 0.4 μm. By preliminarily obtaining the relationship among the setup energy value of the YAG laser, the period of irradiation, and the amount of displacement of the lens and by utilizing an approximation formula or an interpolant formula, the amount of positional aberration can be easily corrected.

FIG. 8 is a perspective view showing another example of configuration of the lens holder 5. The lens holder 5 includes two horizontal members 51a and 51b that extend along X direction, four vertical members 52a, 52b, 53a and 53b that extend along Y direction. A lens 3 is accommodated in a lens cylinder 4, which is held by the lens holder 5 to have the optical axis thereof in Z direction. The vertical members 52a and 52b are fixed to a holder carrier 6 that serves as a base member.

Each of the horizontal members 51a and 51b and the vertical members 52a, 52b, 53a, and 53b is made of a material, such as stainless steel or silicon steel, that is plastically deformable by irradiation with laser light for processing, such as a YAG laser, and is preferably formed of a stainless steel plate having a thickness of 0.3 to 0.4 mm. Each of the lens cylinder 4 and the holder carrier 6 is preferably made of a material similar to that of the horizontal members and the vertical members.

The horizontal members 51a and 51b are shaped such that the horizontal member 51 shown in FIG. 2 is provided with a slit at the center so as to be divided into two portions. The vertical members 52a and 52b extend along Y direction respectively from outer ends of the horizontal member 51a and 51b, and are connected with the holder carrier 6. The vertical members 53a and 53b extend along Y direction respectively from inner ends of the horizontal member 51a and 51b, and the lens cylinder 4 is fixed to lower ends thereof by YAG laser welding or the like. In other words, the vertical members 53a and 53b are interposed respectively between the lens cylinder 4 and the horizontal members 51a and 51b.

In this configuration, when one of the horizontal members 51a and 51b is spot-irradiated with laser light in a manner similar to the case shown in FIG. 3, contraction occurs due to melting and solidification of the material. Because of this contracting deformation, the lens cylinder 4 can be displaced in X direction or −X direction.

When each of the vertical members 52a and 52b is simultaneously spot-irradiated with laser light in a manner similar to the case shown in FIG. 4, contraction occurs due to melting and solidification of the material. Because of this contracting deformation, the lens cylinder 4 can be displaced in −Y direction.

Further, if each of the vertical members 53a and 53b suspending the lens cylinder 4 is simultaneously spot-irradiated with laser light, contraction occurs due to melting and solidification of the material. Contrary to the above case, the lens cylinder 4 can be displaced in Y direction.

In this manner, positional aberration of the lens holder 5 shown in FIG. 8 can be corrected in X direction, −X direction, Y direction and −Y direction.

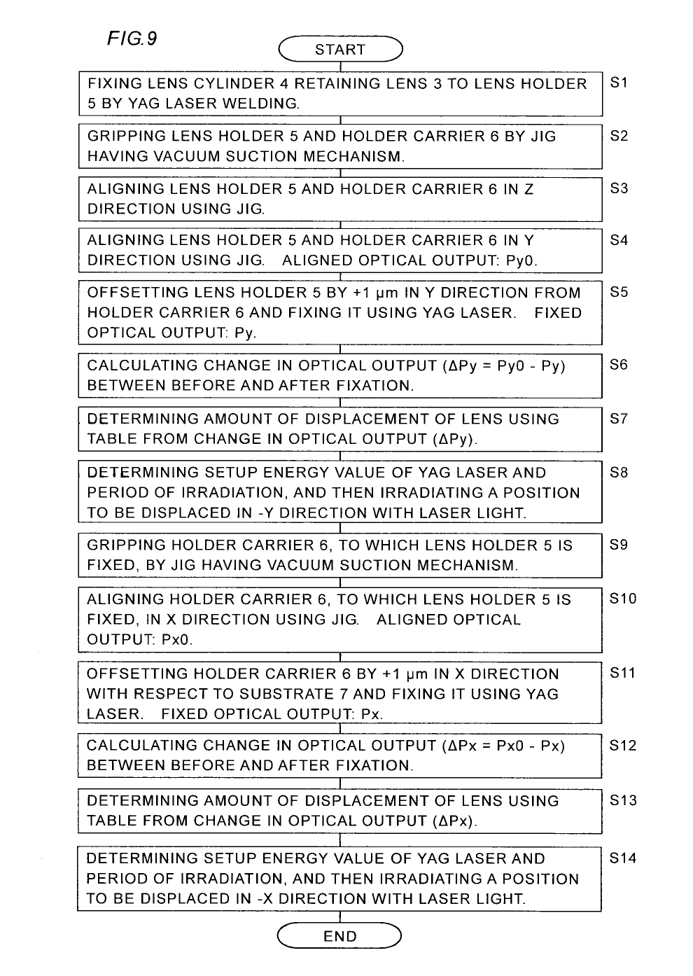

FIG. 9 is a flowchart showing an example of a method of manufacturing an optical apparatus according to the present disclosure. First, the laser light sources 1 and the optical multiplexer 20 are preliminarily fixed onto the substrate 7. In step S1, the lens cylinder 4 retaining the lens 3 is fixed to the lens holder 5 by YAG laser welding or the like. Subsequently in step S2, each of the lens holder 5 and the holder carrier 6 is gripped by a jig having a vacuum suction mechanism, and is positioned on the substrate 7 and between the laser light source 1 and the light incident port of the optical multiplexer 20. The jig used for gripping may have a mechanism other than the vacuum suction mechanism. Subsequently, an optical detector, such as photodiode, is positioned at the light exit port 25 of the optical multiplexer 20, so that the output from the optical multiplexer 20 can be monitored.

Then in step S3, light is emitted from the laser light source 1, and each of the lens holder 5 and the holder carrier 6 is aligned in Z direction parallel to the optical axis direction using the jig having the vacuum suction mechanism so as to maximize the optical output from the optical detector on the substrate 7. Next in step S4, the lens holder 5 is aligned in Y direction using the jig having the vacuum suction mechanism so as to maximize the optical output from the optical detector. Then the optical output Py0 obtained after alignment is memorized.

Then in step S5, each of the holder carrier 6 and the lens holder 5 is fixed by YAG laser welding at a position where the optical output is maximized (maximum optical coupling position). Upon fixing the holder carrier and the lens holder, the lens holder 5 is preferably welded at a position displaced relatively to the holder carrier 6 by a predetermined offset distance in a direction opposite to the plastically deforming direction with respect to the maximum optical coupling position, e.g. at a position away by approximately 1 μm. In other words, the lens 3 in the lens holder shown in FIG. 2 is displaced only in −Y direction by irradiation with laser light. In order to overcome it, when the lens holder is preliminarily offset by a predetermined offset distance, e.g., +1 μm, and fixed, positional correction in Y direction can be realized by irradiation with laser light to cover front and rear ranges with respect to the maximum optical coupling position. After the lens holder 5 is fixed, the optical output Py of the optical detector is memorized.

Then in step S6, a change in optical output (ΔPy=Py0−Py) is calculated between before and after the fixation of the lens holder 5. Next in step S7, from the change in optical output (ΔPy) thus calculated, an amount of displacement of the lens in Y direction is determined using a table or the like expressing the tolerance curves in FIG. 6.

Subsequently in step S8, various irradiation parameters, such as setup energy value of the YAG laser and period of irradiation, are determined in accordance with the amount of displacement of the lens in Y direction thus determined, and laser light is irradiated to a position to be displaced in −Y direction. In this manner, correction on the Y directional positional aberration of the lens 3 is completed.

Then in step S9, the holder carrier 6, to which the lens holder 5 is fixed, is gripped by the jig having the vacuum suction mechanism. Next in step S10, the holder carrier 6 is aligned in X direction using the jig having the vacuum suction mechanism so as to maximize the optical output from the optical detector. Then the optical output Px0 obtained after alignment is memorized.

Thereafter in step S11, the holder carrier 6 is fixed to the substrate 7 by YAG laser welding at a position where the optical output is maximized (maximum optical coupling position). Upon fixing the holder carrier to the substrate, similarly to step S5, the holder carrier 6 is preferably fixed by welding at a position displaced by a predetermined offset distance in a direction opposite to the plastically deforming direction with respect to the maximum optical coupling position, e.g. at a position away by approximately 1 μm. When the holder carrier is preliminarily offset by a predetermined offset distance, e.g., +1 μm and fixed, positional correction in X direction can be realized by irradiation with laser light to cover front and rear ranges with respect to the maximum optical coupling position. After the holder carrier 6 is fixed, the optical output Px of the optical detector is memorized.

Then in step S12, a change in optical output (ΔPx=Px0−Px) is calculated between before and after the fixation of the holder carrier 6. Next in step S13, from the change in optical output (ΔPx) thus calculated, an amount of displacement of the lens in X direction is determined using a table or the like expressing the tolerance curves in FIG. 6.

Subsequently in step S14, various irradiation parameters, such as setup energy value of the YAG laser and period of irradiation, are determined in accordance with the amount of displacement of the lens in X direction thus determined, and laser light is irradiated to a position to be displaced in −X direction. In this manner, correction on the X directional positional aberration of the lens 3 is completed.

Thus, by utilizing plastic deformation caused by irradiation with laser light, it is possible to correct positional aberration of the lens 3 in both of Y direction and X direction. As a result, optical alignment of the lens 3 can be realized accurately and quickly, thereby enhancing the optical coupling efficiency of the lens 3.

In addition, when aligning lenses in the optical transmitter having multiple communication channels shown in FIG. 1, by utilizing plastic deformation caused by irradiation with laser light, the optical coupling efficiency can be enhanced in each of the communication channels as well as differences in optical coupling efficiency can be reduced among the communication channels.

### Embodiment 2

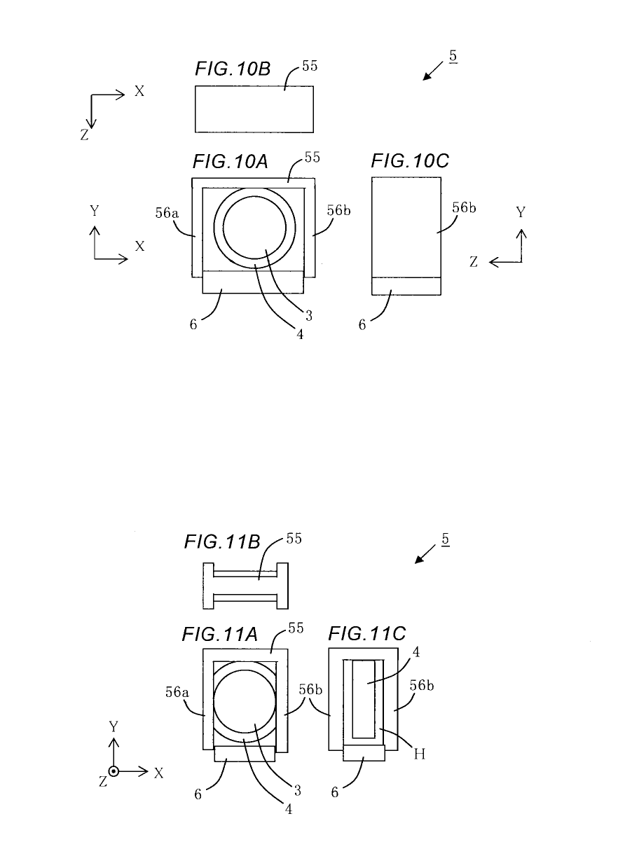

FIGS. 10A to 10C are configuration views according to Embodiment 2 of the present disclosure: FIG. 10A being a front view; FIG. 10B being a plan view; and FIG. 10C being a side view. A lens holder 5 includes a horizontal member 55 that extends along X direction, two vertical members 56a and 56b that extend along Y direction from both ends of the horizontal member 55, and has a shape of so-called gantry. A lens 3 is accommodated in a lens cylinder 4, which is held by the lens holder 5 to have the optical axis thereof in Z direction. The vertical members 56a and 56b are fixed to a holder carrier 6 that serves as a base member.

Each of the horizontal member 55 and the vertical members 56a and 56b is made of a material, such as stainless steel or silicon steel, that is plastically deformable by irradiation with laser light for processing, such as a YAG laser, and is preferably formed of a stainless steel plate having a thickness of 0.3 to 0.4 mm. Each of the lens cylinder 4 and the holder carrier 6 is preferably made of a material similar to that of the horizontal member 55 or the vertical members 56a and 56b. The lens cylinder 4 is fixed using an adhesive or by welding such that the uppermost portion of the lateral surface of the lens cylinder 4 is bonded to the center portion of the horizontal member 55.

In order to perform optical alignment, by spot-irradiating the lens holder 5 with laser light as shown in FIGS. 3 to 5, it is possible to achieve fine adjustment of the position of the lens 3 in +X direction, −X direction, and −Y direction due to contracting deformation of the members.

Instead of fixing the uppermost portion of the lateral surface of the lens cylinder 4 to the horizontal member 55, the leftmost portion of the lateral surface of the lens cylinder 4 can be fixed to the vertical member 56a. In this case, optical alignment is realized only in −X direction.

### Embodiment 3

FIGS. 11A to 11A are configuration views according to Embodiment 3 of the present disclosure: FIG. 11A being a front view; FIG. 11B being a plan view; and FIG. 11C being a side view. A lens holder 5 is configured similarly to that shown in FIGS. 10A to 10C, but is different therefrom in that vertical members 56a and 56b are each provided at the center with an opening H and a lens cylinder 4 is partially inserted into the openings H.

This configuration can reduce the width (in X direction) of the lens holder 5, thereby downsizing it. Furthermore, the vertical members 56a and 56b can be each configured of slim pillars, thereby facilitating plastic deformation by laser spot irradiation. Similarly, by reducing the width of the horizontal member 55, plastic deformation can be easily realized by laser spot irradiation.

### Embodiment 4

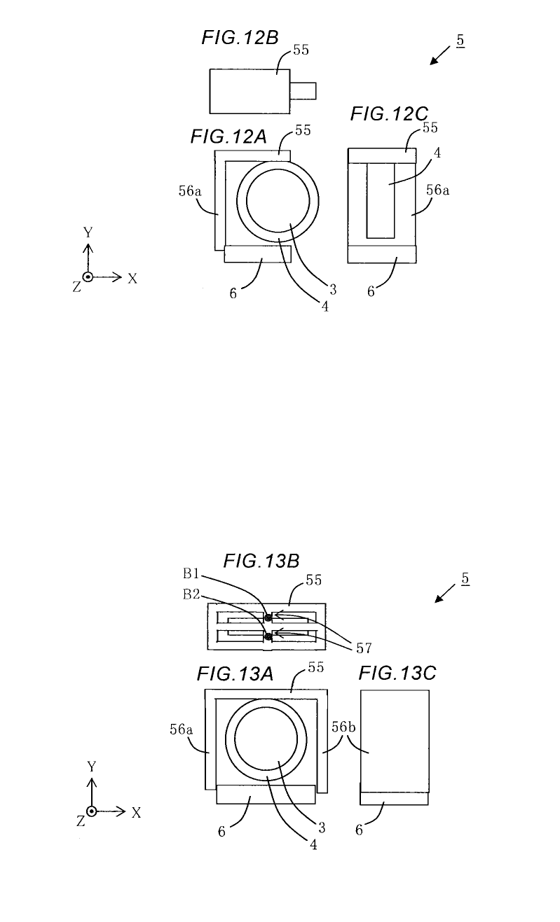

FIGS. 12A to 12C are configuration views according to Embodiment 4 of the present disclosure: FIG. 12A being a front view; FIG. 12B being a plan view; and FIG. 12C being a side view. A lens holder 5 includes, similarly to that shown in FIGS. 10A to 10C, a horizontal member 55 that extends along X direction, a vertical member 56a that extends along Y direction from a one end of the horizontal member 55, so as to be L-shaped. A lens cylinder 4 is fixed using an adhesive or by welding such that the uppermost portion of the lateral surface of the lens cylinder 4 is bonded to a tip end of the horizontal member 55. This configuration can reduce the width (in X direction) of the lens holder 5, thereby downsizing it.

### Embodiment 5

FIGS. 13A to 13C are configuration views according to Embodiment 5 of the present disclosure: FIG. 13A being a front view; FIG. 13B being a plan view; and FIG. 13C being a side view. A lens holder 5 includes, similarly to that shown in FIGS. 10A to 10C, a horizontal member 55 that extends along X direction, two vertical members 56a and 56b that extend along Y direction from both ends of the horizontal member 55, and has a shape of so-called gantry. A lens cylinder 4 is fixed by YAG laser welding or the like such that the uppermost portion of the lateral surface of the lens cylinder 4 is bonded to the center portion of the horizontal member 55.

In this embodiment, the horizontal member 55 is formed with a shape of lattice, having a plurality of X members that extend along X direction and a Z member 57 that extends along Z direction (in the optical axis direction). The lens cylinder 4 is fixed using an adhesive or by welding such that the uppermost portion of the lateral surface of the lens cylinder 4 is bonded to portions where the X members and the Z member 57 cross each other.

In order to perform optical alignment, by spot-irradiating the lens holder 5 with laser light as shown in FIGS. 3 to 5, it is possible to achieve fine adjustment of the position of the lens 3 in +X direction, −X direction, and −Y direction due to contracting deformation of the members.

Furthermore, in this embodiment, irradiation areas B1 and B2 are provided on the front and rear sides of the lens 3 on the surface of the Z member 57. When the irradiation area B1 is spot-irradiated with laser light, fine adjustment of the position of the lens 3 can be achieved in −Z direction. On the other hand, when the irradiation area B2 is spot-irradiated with laser light, fine adjustment of the position of the lens 3 can be achieved in +Z direction.

### Embodiment 6

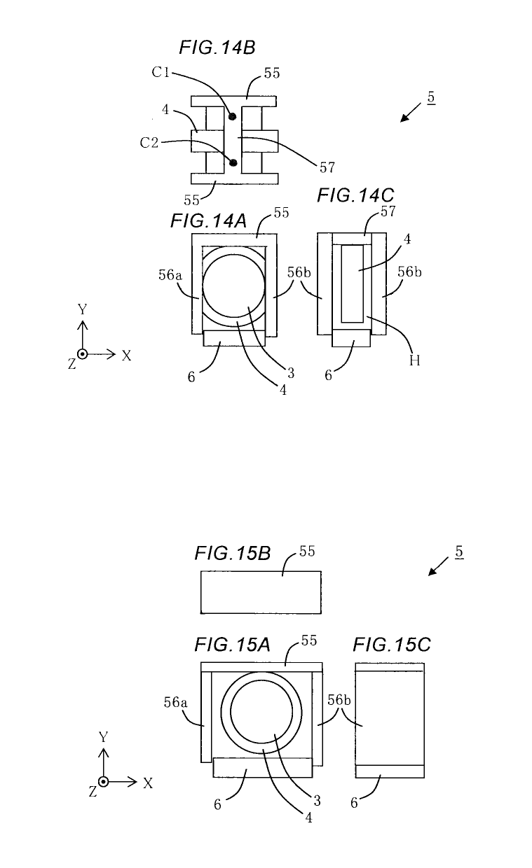

FIGS. 14A to 14C are configuration views according to Embodiment 6 of the present disclosure: FIG. 14A being a front view; FIG. 14B being a plan view; and FIG. 14C being a side view. A lens holder 5, in which the lateral surface thereof is partially cut off and a horizontal member 55 has a narrow width in the Z direction, as shown in FIGS. 11A to 11C, is located after rotating by 90 degrees in ZX plane. The lens holder 5 includes, similarly to that shown in FIGS. 10A to 10C, the horizontal member 55 that extends along X direction, two vertical members 56a and 56b that extend along Y direction from both ends of the horizontal member 55, and has a shape of so-called gantry. The vertical members 56a and 56b are each provided at the center with an opening H. A lens cylinder 4 is partially inserted into the openings H, thereby reducing the width (in X direction) of the lens holder 5.

In this embodiment, the horizontal member 55 has a plurality of X members that extend along X direction and a Z member 57 that extends along Z direction (in the optical axis direction). The lens cylinder 4 is fixed using an adhesive or by welding such that the uppermost portion of the lateral surface of the lens cylinder 4 is bonded to the center portion of the Z member 57.

In order to perform optical alignment, by spot-irradiating the lens holder 5 with laser light as shown in FIGS. 3 to 5, it is possible to achieve fine adjustment of the position of the lens 3 in +X direction, −X direction, and −Y direction due to contracting deformation of the members.

Furthermore, in this embodiment, irradiation areas C1 and C2 are provided on the front and rear sides of the lens 3 on the surface of the Z member 57. When the irradiation area C1 is spot-irradiated with laser light, fine adjustment of the position of the lens 3 can be achieved in −Z direction. On the other hand, when the irradiation area

C2 is spot-irradiated with laser light, fine adjustment of the position of the lens 3 can be achieved in +Z direction.

### Embodiment 7

FIGS. 15A to 15C are configuration views according to Embodiment 7 of the present disclosure: FIG. 15A being a front view; FIG. 15B being a plan view; and FIG. 15C being a side view. A lens holder 5 is configured similarly to that shown in FIGS. 10A to 10C, but the horizontal member 55 and the vertical members 56a and 56b are configured of flat plate members and are connected together using an adhesive or by welding. This configuration can reduce a cost for producing the lens holder 5.

### Embodiment 8

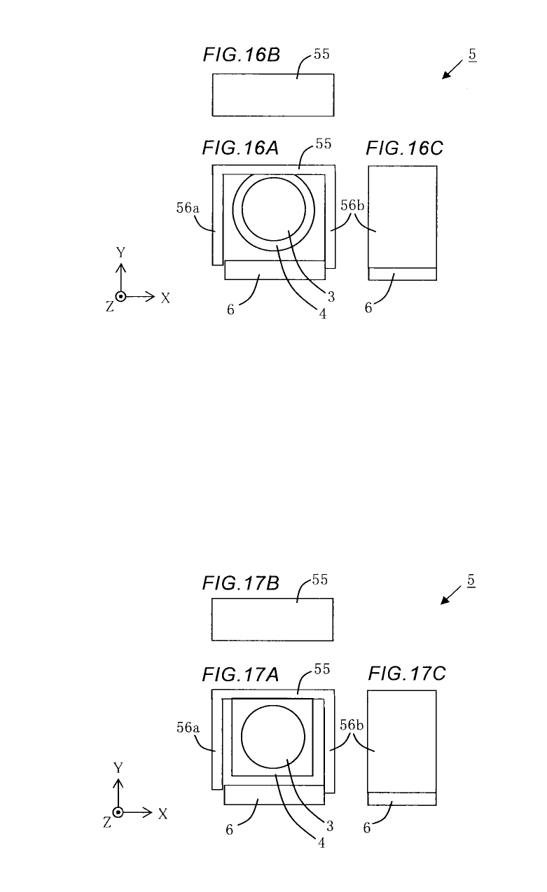

FIGS. 16A to 16C are configuration views according to Embodiment 8 of the present disclosure: FIG. 16A being a front view; FIG. 16B being a plan view; and FIG. 16C being a side view. A lens holder 5 is configured similarly to that shown in FIGS. 10A to 10C, but is different therefrom in that the lens cylinder 4 is provided on the lateral surface with a flat portion, so-called D-cutting. The lens cylinder 4 is connected to the horizontal member 55 via the flat portion. This configuration can increase a bonding area between the lens holder 5 and the lens cylinder 4, thereby enhancing joint strength therebetween.

### Embodiment 9

FIGS. 17A to 17C are configuration views according to Embodiment 9 of the present disclosure: FIG. 17A being a front view; FIG. 17B being a plan view; and FIG. 17C being a side view. A lens holder 5 is configured similarly to that shown in FIGS. 10A to 10C, but is different therefrom in that the lens cylinder 4 has a rectangular plate shape provided with a circular through hole and the lens cylinder 4 is provided on the lateral surface with a flat portion. The lens cylinder 4 is connected to the horizontal member 55 via the flat portion. This configuration can increase a bonding area between the lens holder 5 and the lens cylinder 4, thereby enhancing joint strength therebetween. Furthermore, the lens cylinder 4 has such a rectangular plate shape, thereby leading to reduction in cost for producing the lens cylinder 4.

### Embodiment 10

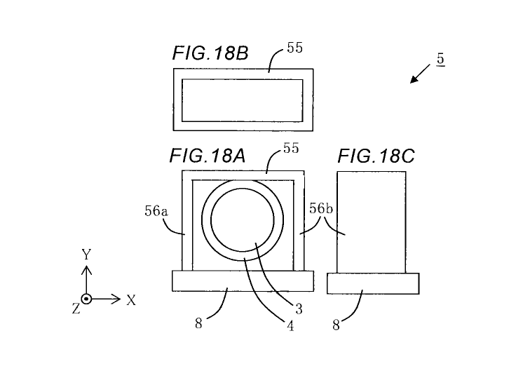

FIGS. 18A to 18C are configuration views according to Embodiment 10 of the present disclosure: FIG. 18A being a front view; FIG. 18B being a plan view; and FIG. 18C being a side view. A lens holder 5 is configured similarly to that shown in FIGS. 10A to 10C, but the holder carrier 6 serving as a base member is replaced with a fixing plate 8, to which the lens holder 5 is bonded directly. This configuration can reduce the number of components, thereby leading to reduction in cost for producing the lens holder 5.

The above description exemplifies usage of a YAG laser in order to perform spot welding or plastic deformation of the member by melting and solidification. The YAG laser can be replaced with any other high output laser, such as CO₂ laser, solid state laser, or semiconductor laser. In a case where the members are made of resin, it is also possible to use an excimer laser or the like.

Although the present disclosure has been fully described in connection with the preferred embodiments thereof and the accompanying drawings, it is to be noted that various changes and modifications are apparent to those skilled in the art. Such changes and modifications are to be understood as included within the scope of the present disclosure as defined by the appended claims unless they depart therefrom.

What is claimed is:

1. A method of manufacturing an optical apparatus, the optical apparatus comprising:
an optical element having an optical axis in a predetermined direction;
a holding member for holding the optical element; and
a base member onto which the holding member is fixed;
the method including steps of:
preparing the holding member having a first member that extends along a first direction perpendicular to an optical axis direction and a second member that extends along a second direction perpendicular to both the optical axis direction and the first direction;
fixing the optical element to the first member;
fixing the second member to the base member;
plastically deforming the first member by irradiation with laser light to adjust the position of the optical element in the first direction; and
plastically deforming the second member by irradiation with laser light to adjust the position of the optical element in the second direction.

2. The method of manufacturing the optical apparatus according to claim 1, further including, before the steps of fixing the optical element and fixing the second member, steps of:
preparing a second optical element to be optically coupled with the optical element; and
aligning the optical axis of the optical element with that of the second optical element so as to maximize optical coupling between the optical element and the second optical element; wherein, in the step of fixing the optical element to the first member, the optical element is fixed at a position displaced by a predetermined offset distance in a direction opposite to a plastically deforming direction with respect to a maximum optical coupling position thereof, and
in the step of fixing the second member to the base member, the second member is fixed at a position displaced by a predetermined offset distance in a direction opposite to a plastically deforming direction with respect to a maximum optical coupling position thereof.

3. The method of manufacturing the optical apparatus according to claim 1, wherein the holding member has one first member and two second members that are connected to both ends of the first member.

4. The method of manufacturing the optical apparatus according to claim 1, wherein the holding member further has a third member that extends along the second direction, and
in the step of fixing the optical element to the first member, the third member is interposed between the optical element and the first member.

5. The method of manufacturing the optical apparatus according to claim 1, wherein the optical apparatus comprises:
a lens serving as the optical element,
a laser light source that is optically coupled with the lens,
an optical multiplexer that is optically coupled with the lens, and
a substrate on which the laser light source, the optical multiplexer, and the base member are mounted.

6. An optical apparatus comprising:
an optical element having an optical axis in a predetermined direction;
a holding member for holding the optical element; and
a base member onto which the holding member is fixed;
wherein the holding member has a first member that extends along a first direction perpendicular to an optical axis direction and a second member that extends along a second direction perpendicular to both the optical axis direction and the first direction, and
each of the first member and the second member is made of a material that is plastically deformable by irradiation with laser light.

7. An optical apparatus comprising:
a lens having an optical axis in a predetermined direction;
a lens cylinder accommodating the lens;
a holding member for holding the lens cylinder; and
a base member onto which the holding member is fixed;
wherein the holding member has a first member that extends along a first direction perpendicular to an optical axis direction and a second member that extends along a second direction perpendicular to both the optical axis direction and the first direction,
each of the first member and the second member is made of a material that is plastically deformable by irradiation with laser light, and
the lens cylinder has a lateral surface connected with the first member.

8. The optical apparatus according to claim 7, wherein the second member is provided with an opening into which the lens cylinder is partially inserted.

9. The optical apparatus according to claim 7, wherein the holding member has one first member, and two second members that are connected to both ends of the first member.

10. The optical apparatus according to claim 7, wherein the holding member has one first member, and one second member that is connected to a one end of the first member.

11. The optical apparatus according to claim 7, wherein the holding member further has a third member that extends along the optical axis direction, and the lens cylinder is connected with the third member.

12. The optical apparatus according to claim 7, wherein each of the first member and the second member is configured of a flat plate.

13. The optical apparatus according to claim 7, wherein the lateral surface of the lens cylinder is provided with a flat portion, and the lens cylinder is connected with the retentive member via the flat portion.

14. The optical apparatus according to claim 7, wherein the lens cylinder is connected with the holding member using an adhesive or by welding.
